(19) United States
(12) Patent Application Publication
(10) Pub. No.: US 2025/0062515 A1
(43) Pub. Date: Feb. 20, 2025

(54) LEAD WIRE FOR NONAQUEOUS ELECTROLYTE BATTERY, INSULATING FILM, AND NONAQUEOUS ELECTROLYTE BATTERY

(71) Applicant: SUMITOMO ELECTRIC INDUSTRIES, LTD., Osaka (JP)

(72) Inventor: Shunsuke OKAMOTO, Osaka (JP)

(73) Assignee: SUMITOMO ELECTRIC INDUSTRIES, LTD., Osaka (JP)

(21) Appl. No.: 18/721,797

(22) PCT Filed: Aug. 12, 2022
(86) PCT No.: PCT/JP2022/030817

§ 371 Date: Jun. 19, 2024

(30) Foreign Application Priority Data
Dec. 23, 2021 (WO) PCT/JP2021/048001

(51) Int. Cl. H01M 50/586; H01M 50/119; H01M 50/129; H01M 50/533

(52) U.S. Cl. CPC H01M 50/586; H01M 50/119; H01M 50/129; H01M 50/533

(57) ABSTRACT

The lead wire for a nonaqueous electrolyte battery according to the present disclosure includes a conductor and an insulating film having one or more insulating layers and covering at least a part of an outer peripheral surface of the conductor, and a summation Σ(T×E_{D}) of a product of an average thickness T of each of the insulating layers and an elastic modulus E_{D} thereof at a temperature D in a temperature range of 70° C. or more and 130° C. or less is 0.6 mm·MPa or more.

The present application claims priority based on International Application No. PCT/JP2021/048001 filed on Dec. 23, 2021, and the contents described in the foregoing international application are incorporated herein by reference in their entirety.

### TECHNICAL FIELD

The present disclosure relates to a lead wire for a nonaqueous electrolyte battery, an insulating film, and a nonaqueous electrolyte battery.

### BACKGROUND ART

As an electronic device becomes smaller and lighter, an electric part such as a battery or a capacitor used in the device is also required to be smaller and lighter. Because of this, for example, a nonaqueous electrolyte battery that uses a bag body as an enclosure and has a nonaqueous electrolyte (electrolytic solution), a positive electrode, and a negative electrode enclosed inside the enclosure is adopted. As the nonaqueous electrolyte, an electrolytic solution obtained by dissolving a fluorine-containing lithium salt such as LiPF₆ or LiBF₄ in propylene carbonate, ethylene carbonate, dimethyl carbonate, diethyl carbonate, ethyl methyl carbonate, or the like is used.

The enclosure is required to have the property of preventing the permeation of an electrolytic solution and a gas, and the entry of water from the outside. Because of this, a laminate film obtained by covering a metal layer such as aluminum foil with a resin is used as a material for the enclosure, and end portions of two laminate films are heat-sealed to form the enclosure.

One end of the enclosure is an opening portion, and a nonaqueous electrolyte, a positive electrode plate, a negative electrode plate, a separator, and the like are enclosed inside the enclosure. Furthermore, lead conductors having one ends connected to the positive electrode plate and the negative electrode plate, respectively, are disposed in such a way as to extend from the inside to the outside of the enclosure, and finally the opening portion is heat-sealed to close the opening portion of the enclosure and adhere the enclosure and the lead conductors to seal the opening portion. The portion that is finally heat-sealed is referred to as a seal portion.

Each portion of the lead conductors corresponding to the seal portion is covered with an insulating film, and a thing including an insulating film and a lead conductor is referred to as a lead wire (tab lead) for a nonaqueous electrolyte battery. The enclosure and the lead conductor are adhered (heat-sealed) with this insulating film interposed therebetween. Therefore, this insulating film is required to have the property of being able to maintain the adhesiveness between the lead conductor and the enclosure without causing a short circuit between the metal layer of the enclosure and the lead conductor.

As such a tab lead, for example, in the prior art, a lead wire for a nonaqueous electrolyte battery including an insulator on the outside of a composite coating layer, the composite coating layer being formed by applying a treatment liquid including a resin component including polyacrylic acid and polyacrylic amide and a metal salt to a lead conductor has been proposed (see PTL 1).

### CITATION LIST

### Patent Literature

PTL 1: Japanese Patent Laying-Open No. 2006-128096

### SUMMARY OF INVENTION

The lead wire for a nonaqueous electrolyte battery according to the present disclosure includes a conductor and an insulating film having one or more insulating layers and covering at least a part of an outer peripheral surface of the conductor, wherein the summation Σ(T×E_{D}) of the product of the average thickness T of each of the insulating layers and the elastic modulus E_{D} thereof at a temperature D in a temperature range of 70° C. or more and 130° C. or less is 0.6 mm·MPa or more.

### BRIEF DESCRIPTION OF DRAWINGS

FIG. 1 is a perspective view of a lead wire for a nonaqueous electrolyte battery according to one embodiment of the present disclosure.

FIG. 2 is a partial cross-sectional view of a lead wire for a nonaqueous electrolyte battery according to one embodiment of the present disclosure.

FIG. 3 is a perspective view showing one example of a nonaqueous electrolyte battery including lead wires for a nonaqueous electrolyte battery according to one embodiment of the present disclosure.

FIG. 4 is a longitudinal sectional view of the nonaqueous electrolyte battery of FIG. 3.

### DETAILED DESCRIPTION

### Problem to be Solved by the Present Disclosure

In recent years, in response to the demand for a shorter charging time or a longer cruising distance for an electric vehicle, an automotive nonaqueous electrolyte battery has been required to have the rapid charging and discharging property of enabling large current charging and discharging in a short period of time. With such rapid charging and discharging of a nonaqueous electrolyte battery, the environment in which the nonaqueous electrolyte battery is used has a higher temperature. Because of this, a material constituting a nonaqueous electrolyte battery is required to have higher heat resistance than ever before, and it is an issue to improve the adhesiveness between a conductor and an insulating film at a high temperature.

An object of the present disclosure is to provide a lead wire for a nonaqueous electrolyte battery that has excellent adhesiveness between a conductor and an insulating film at a high temperature.

### Advantageous Effect of the Present Disclosure

According to the present disclosure, it is possible to provide a lead wire for a nonaqueous electrolyte battery that has excellent adhesiveness between a conductor and an insulating film at a high temperature.

### DESCRIPTION OF EMBODIMENTS

First, embodiments of the present disclosure will be listed and described.

The lead wire for a nonaqueous electrolyte battery according to the present disclosure includes a conductor and an insulating film having one or more insulating layers and covering at least a part of an outer peripheral surface of the conductor, and the summation Σ(T×E_{D}) of the product of the average thickness T of each of the insulating layers and the elastic modulus E_{D} thereof at a temperature D in a temperature range of 70° C. or more and 130° C. or less is 0.6 mm·MPa or more.

The present inventors have found that in a lead wire for a nonaqueous electrolyte battery, the greater the thickness of each of the insulating layers constituting the insulating film covering at least a part of the outer peripheral surface of the conductor and the higher the elastic modulus, the more difficult the lead wire is to deform, and the more improved the peel strength. In the lead wire for a nonaqueous electrolyte battery, when the summation Σ(T×E_{D}) of the product of the average thickness T of each of the insulating layers constituting the insulating film and the elastic modulus E_{D} thereof at a temperature D in a high temperature range of 70° C. or more and 130° C. or less is 0.6 mm·MPa or more, the peel strength of the insulating film is high even at a high temperature. Therefore, the lead wire for a nonaqueous electrolyte battery has excellent adhesiveness between the conductor and the insulating film at a high temperature.

The “elastic modulus” is measured by using a nanoindenter. The measurement of the elastic modulus with a nanoindenter (nanoindentation method) is carried out according to the following procedure. As the nanoindenter, TriboIndenter TI980 manufactured by HYSITRON is used. In the nanoindenter, an equilateral triangular pyramidal indenter whose tip consists of a diamond tip (Berkovich indenter) was used. Each adhesive film, which is a measurement sample, is cut in the lamination direction, and a cross section of the insulating film is exposed by Ar ion milling. Next, by using a nanoindenter, an indenter is pressed in a direction perpendicular to the cross section of the insulating film under the following measurement conditions, a load-displacement curve is measured, and the elastic modulus is calculated.
(1) Indentation time: 3 seconds
(2) Holding time: 0 seconds
(3) Unloading time: 0 seconds
(4) Loading speed: 8 mN/sec
(5) Indentation load: 0.5 mN to 5 mN (this is appropriately adjusted such that the impression size is about 10 μm to 20 μm)
(6) Indentation depth arrival time: 5 seconds
(7) Load holding time: 0 seconds
(8) Indentation depth unloading time: 5 seconds

Preferably, the summation of the average thickness T of each of the insulating layers is 0.10 mm or more and 1.00 mm or less, and the elastic modulus E_{D} of each of the insulating layers is 1 MPa or more. In the lead wire for a nonaqueous electrolyte battery, when the summation of the average thickness T of each of the insulating layers is 0.10 mm or more and 1.00 mm or less, and the elastic modulus E_{D} of each of the insulating layers is 1 MPa or more, the peel strength of the insulating film at a high temperature increases, and thus the adhesiveness between the conductor and the insulating film can be more improved.

The summation Σ(T×E_{D}) of the product of the average thickness T of each of the insulating layers and the elastic modulus E_{D} thereof is preferably 3.0 mm·MPa or more. When the summation Σ(T×E_{D}) of the product of the average thickness T of each of the insulating layers and the elastic modulus E_{D} thereof is 3.0 mm·MPa or more, the peel strength of the insulating film at a high temperature increases, and thus the adhesiveness between the conductor and the insulating film can be more improved.

Preferably, the summation of the average thickness T of each of the insulating layers is 0.10 mm or more and 1.00 mm or less, and the elastic modulus E_{D} of each of the insulating layers is 3.0 MPa or more. When the summation of the average thickness T of each of the insulating layers is 0.10 mm or more and 1.00 mm or less, and the elastic modulus E_{D} of each of the insulating layers is 3.0 MPa or more, the peel strength of the insulating film at a high temperature more increases, and thus the adhesiveness between the conductor and the insulating film can be further improved.

The summation Σ(T×E_{D}) of the product of the average thickness T of each of the insulating layers and the elastic modulus E_{D} thereof is preferably 5.0 mm·MPa or more. When the summation Σ(T×E_{D}) of the product of the average thickness T of each of the insulating layers and the elastic modulus E_{D} thereof is 5.0 mm·MPa or more, the peel strength of the insulating film at a high temperature more increases, and thus the adhesiveness between the conductor and the insulating film can be further improved.

Preferably, the summation of the average thickness T of each of the insulating layers is 0.10 mm or more and 1.00 mm or less, and the elastic modulus E_{D} of each of the insulating layers is 5.0 MPa or more. When the summation of the average thickness T of each of the insulating layers is 0.10 mm or more and 1.00 mm or less, and the elastic modulus E_{D} of each of the insulating layers is 5.0 MPa or more, the peel strength of the insulating film at a high temperature more increases, and thus the adhesiveness between the conductor and the insulating film can be further improved.

The summation Σ(T×E_{D}) of the product of the average thickness T of each of the insulating layers and the elastic modulus E_{D} thereof is preferably 7.0 mm·MPa or more. When the summation Σ(T×E_{D}) of the product of the average thickness T of each of the insulating layers and the elastic modulus E_{D} thereof is 7.0 mm·MPa or more, the peel strength of the insulating film at a high temperature more increases, and thus the adhesiveness between the conductor and the insulating film can be further improved.

The summation Σ(T×E_{D}) of the product of the average thickness T of each of the insulating layers and the elastic modulus E_{D} thereof is preferably 15.0 mm·MPa or more. When the summation Σ(T×E_{D}) of the product of the average thickness T of each of the insulating layers and the elastic modulus E_{D} thereof is 15.0 mm·MPa or more, the peel strength of the insulating film at a high temperature more further increases, and thus the adhesiveness between the conductor and the insulating film can be more further improved.

Preferably, the insulating film has a first insulating layer laminated on the surface of the conductor, and the elastic modulus E₁₃₀ at 130° C. of the first insulating layer is 130 MPa or more. When the elastic modulus E₁₃₀ at 130° C. of the first insulating layer is 130 MPa or more, the peel strength of the insulating film at a high temperature more increases, and thus the adhesiveness between the conductor and the insulating film can be more improved.

The first insulating layer preferably includes a polypropylene or an acid-modified polypropylene having a melting point of 150° C. or more as a main component. When the first insulating layer includes a polypropylene or an acid-modified polypropylene having a melting point of 150° C. or more as a main component, the peel strength of the insulating film at a high temperature more increases, and thus the adhesiveness between the conductor and the insulating film can be more improved.

The insulating film is used for the lead wire for a nonaqueous electrolyte battery according to the present disclosure. When the lead wire for a nonaqueous electrolyte battery uses the insulating film, the lead wire for a nonaqueous electrolyte battery has excellent adhesiveness between the conductor and the insulating film at a high temperature.

The nonaqueous electrolyte battery of the present disclosure includes an enclosure and a plurality of lead wires for a nonaqueous electrolyte battery disposed in such a way as to extend from the inside to the outside of the enclosure, wherein the enclosure is constituted of a sheet body having an innermost resin layer, a metal layer, and an outermost resin layer laminated in presented order, and the innermost resin layer and the insulating layer on the outermost surface of the insulating film are heat-sealed.

The nonaqueous electrolyte battery includes a plurality of lead wires for a nonaqueous electrolyte battery, and thus has excellent adhesiveness between the conductors of the lead wires and the insulating film at a high temperature.

### DETAILS OF EMBODIMENTS OF PRESENT DISCLOSURE

Hereinafter, the lead wire for a nonaqueous electrolyte battery and the nonaqueous electrolyte battery according to the present disclosure will be described in detail.

### <Lead Wire for Nonaqueous Electrolyte Battery>

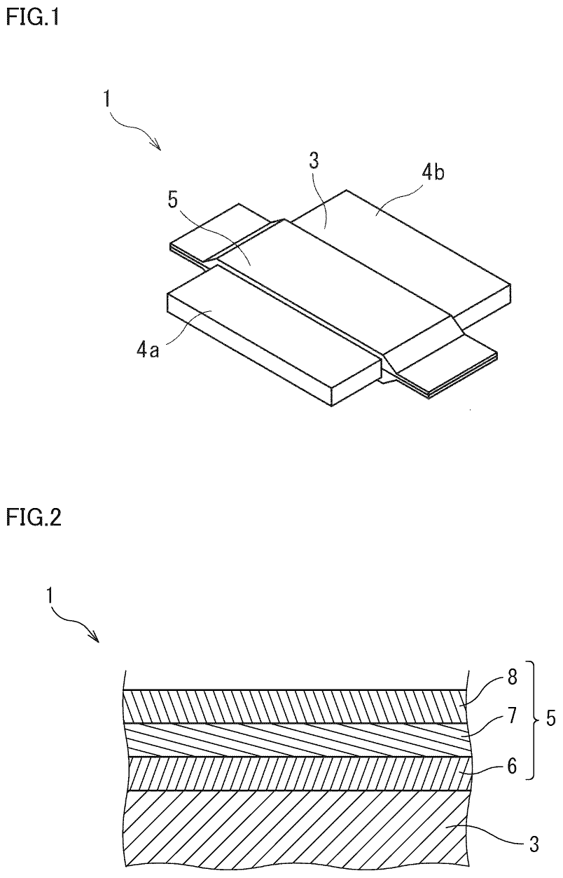

The lead wire for a nonaqueous electrolyte battery includes a conductor and an insulating film having one or more insulating layers and covering at least a part of the outer peripheral surface of the conductor. FIG. 1 is a perspective view of a lead wire for a nonaqueous electrolyte battery according to one embodiment of the present disclosure. FIG. 2 is a partial cross-sectional view of a lead wire for a nonaqueous electrolyte battery according to one embodiment of the present disclosure. As shown in FIG. 1 and FIG. 2, a lead wire 1 for a nonaqueous electrolyte battery includes a conductor 3 and an insulating film 5 covering at least a part of the outer peripheral surface of conductor 3. Insulating film 5 has a first insulating layer 6 laminated on the surface of conductor 3, a second insulating layer 7 laminated on the surface of first insulating layer 6, and a third insulating layer 8 laminated on the surface of second insulating layer 7.

In the present embodiment, lead wire 1 for a nonaqueous electrolyte battery includes insulating film 5 having a three-layer structure consisting of first insulating layer 6, second insulating layer 7, and third insulating layer 8, and the insulating film of the lead wire for a nonaqueous electrolyte battery may have, for example, only the first insulating layer, or may have only the first insulating layer and the second insulating layer. As described above, the number of layers of the insulating film of the lead wire for a nonaqueous electrolyte battery may be one, two, or four or more.

### (Conductor)

Conductor 3 is connected to an electrode or the like of a nonaqueous electrolyte battery. The material of conductor 3 is not particularly limited as long as the material is used as a conductor constituting lead wire 1 for a nonaqueous electrolyte battery, and examples thereof include a metal material such as aluminum, titanium, nickel, copper, an aluminum alloy, a titanium alloy, a nickel alloy, or a copper alloy, and a material obtained by plating such a metal material with nickel, gold, or the like. As a material for forming conductor 3 connected to a positive electrode of a nonaqueous electrolyte battery, a material that does not dissolve during discharge is preferable, and specifically, aluminum, titanium, an aluminum alloy, and a titanium alloy are preferable. On the other hand, as a material for forming conductor 3 connected to a negative electrode, nickel, copper, a nickel alloy, a copper alloy, nickel-plated copper, and gold-plated copper are preferable. In addition, conductor 3 may be surface-treated in order to prevent corrosion due to an electrolyte.

The lower limit of the average thickness of conductors 3 is preferably 0.10 mm. When the average thickness of conductor 3 is 0.10 mm or more, a sufficient amount of current can be caused to flow therethrough for practical use as a battery. In addition, the lower limit of the average thickness of conductor 3 may be 0.15 mm or 0.20 mm. On the other hand, the upper limit of the average thickness of conductor 3 is not particularly limited, and can be appropriately set according to, for example, the capacity of the nonaqueous electrolyte battery. For example, the upper limit of the average thickness is preferably 5.00 mm. When the average thickness of conductor 3 is 5.00 mm or less, resistance heat generation of lead wire 1 for a nonaqueous electrolyte battery can be suppressed even if lead wire 1 for a nonaqueous electrolyte battery is rapidly charged and discharged. Furthermore, the upper limit of the average thickness of conductor 3 may also be 4 mm. The “average thickness” of conductor 3 is the average value of thickness measurements at 10 points. “Average thickness” as used hereinafter is synonymous therewith.

### (Insulating Film)

Insulating film 5 is used as an insulating film of lead wire 1 for a nonaqueous electrolyte battery. In the present embodiment, insulating film 5 has three layers and is laminated on the outer peripheral surface of conductor 3 in such a way as to cover at least a part of the outer peripheral surface of conductor 3. When lead wire 1 for a nonaqueous electrolyte battery includes insulating film 5, the corrosion of conductor 3 can be suppressed, and the adhesiveness to the enclosure can be enhanced to impart a good sealing property.

The average thickness of insulating film 5, that is, the lower limit of the summation ET of the average thickness T of each of the insulating layers constituting insulating film 5 is preferably 0.10 mm. When the average thickness of insulating film 5 is less than 0.10 mm, sufficient adhesiveness of insulating film 5 to the conductor at a high temperature may be unable to be obtained. On the other hand, the average thickness of insulating film 5, that is, the upper limit of the summation ET of the average thicknesses T of each of the insulating layers constituting insulating film 5 is preferably 1.00 mm, more preferably 0.60 mm, and further preferably 0.30 mm. When the average thickness of insulating film 5 exceeds 1.00 mm, the amount of water that permeates insulating film 5 from the air and enters the inside of the nonaqueous electrolyte battery may increase to accelerate the deterioration of the nonaqueous electrolyte battery. Here, in the present disclosure, the average thickness of insulating film 5 is the average value of the measured values of the thickness at 10 points on a surface having the largest area on the outer peripheral surface of insulating film 5.

The lower limit of the average thickness T of each of the insulating layers is preferably 0.02 mm, and more preferably 0.03 mm. When the average thickness T of each of the insulating layers is less than 0.02 mm, sufficient adhesiveness of the insulating film to the conductor at a high temperature may be unable to be obtained. On the other hand, the upper limit of the average thickness T of each of the insulating layers is preferably 0.12 mm, and more preferably 0.10 mm. When the average thickness T of each of the insulating layers exceeds 0.12 mm, the amount of water that permeates insulating film 5 from the air and enters the inside of the nonaqueous electrolyte battery may increase to accelerate the deterioration of the nonaqueous electrolyte battery. Here, in the present disclosure, the average thickness T of each of the insulating layers is the average value of the measured values of the thickness at 10 points on a surface having the largest area on the outer peripheral surface of the insulating layer.

Each of the insulating layers more preferably includes an olefin-based thermoplastic resin as a main component. Here, in the present disclosure, the main component means a component having the highest content ratio in terms of mass, and for example, means a component having a content of 50% by mass or more in each of the insulating layers, and furthermore the content may be 80% % by mass or more, 90% % by mass or more, or 100% by mass. Examples of the olefin-based thermoplastic resin include a polypropylene, polyethylene, and a derivative thereof. Examples of the derivative include an acid-modified polyolefin. The acid-modified polyolefin is preferably an acid-modified polypropylene, and when the acid-modified polyolefin is an acid-modified polypropylene, the adhesiveness between the insulating layers more improves. That is, the olefin-based thermoplastic resin is preferably a polypropylene or an acid-modified polypropylene. When the olefin-based thermoplastic resin is a polypropylene or an acid-modified polypropylene, the olefin-based thermoplastic resin has adhesiveness to the conductor and can sufficiently exhibit adhesiveness between the insulating layers.

Examples of the polypropylene include random polypropylene having a melting point of 120° C. or more and 155° C. or less, homopolypropylene having a high melting point of more than 155° C., block polypropylene, and a propylene-based thermoplastic elastomer (TPO). When the polyolefin is random polypropylene, there is the following advantage: the adhesiveness between the insulating layers and between the insulating layer and the innermost resin layer of the enclosure can be sufficiently exhibited. In addition, by including a polyolefin resin having a high melting point, when an opening portion of the enclosure is heat-sealed, it is difficult to melt at the heat sealing temperature, and a short circuit between the metal layer of the enclosure and the conductor can be suppressed.

The acid used for acid modification is not particularly limited as long as the acid does not impair the effect of the present invention, and examples thereof include an unsaturated carboxylic acid and a derivative thereof. Examples of the unsaturated carboxylic acid include acrylic acid, methacrylic acid, maleic acid, itaconic acid, and fumaric acid. Examples of the derivative of an unsaturated carboxylic acid include a maleic acid monoester, maleic anhydride, an itaconic acid monoester, itaconic anhydride, a fumaric acid monoester, and fumaric anhydride. Among these, a derivative of an unsaturated carboxylic acid is preferable, and maleic anhydride is more preferable, from the viewpoint of being able to more improve the adhesiveness (compatibility) between an olefin-based resin and a liquid crystal polymer.

In addition, the olefin-based thermoplastic resin may be a crosslinked polyolefin. When the insulating layer includes a crosslinked polyolefin, when an opening portion of the enclosure is heat-sealed, it is difficult to melt at the heat sealing temperature, and a short circuit between the metal layer of the enclosure and the conductor can be suppressed. Examples of the polyolefin in the crosslinked polyolefin include a polypropylene, polyethylene, and a derivative thereof. The crosslinked polyolefin is preferably crosslinked random polypropylene having a melting point of 130° C. or more and 170° C. or less. By using the crosslinked random polypropylene, the adhesiveness between the insulating layers is more improved, and it is more difficult to melt at the heat sealing temperature.

First insulating layer 6 preferably includes a polypropylene or an acid-modified polypropylene having a melting point of 150° C. or more as a main component. When first insulating layer 6 includes a polypropylene or an acid-modified polypropylene having a melting point of 150° C. or more as a main component, the peel strength of insulating film 5 at a high temperature more increases, and thus the adhesiveness between conductor 3 and insulating film 5 can be more improved. Examples of the polypropylene and acid-modified polypropylene having a melting point of 150° C. or more include homopolypropylene, block polypropylene, and acid-modified homopolypropylene, as described above.

Each of the insulating layers may contain a further olefin-based thermoplastic resin other than the above olefin-based thermoplastic resins in a range that does not inhibit the effect of the present disclosure. Specifically, each of the insulating layers may contain a plurality of resins, and examples of the further olefin-based thermoplastic resin include a combination of low-density polyethylene, linear low-density polyethylene, a low-crystallinity ethylene-propylene copolymer, a low-crystallinity ethylene-butylene copolymer, a low-crystallinity ethylene-octene copolymer, a low-crystallinity propylene-ethylene copolymer, low-crystallinity polypropylene, and the like.

The lower limit of the summation Σ(T×E_{D}) of the product of the average thickness T of each of the insulating layers and the elastic modulus E_{D} thereof at a temperature D in a temperature range of 70° C. or more and 130° C. or less is 0.6 mm·MPa, preferably 3.0 mm·MPa, more preferably 5.0 mm·MPa, more further preferably 7.0 mm·MPa, and particularly preferably 15.0 mm·MPa. The upper limit of the summation Σ(T×E_{D}) of the product of the average thickness T and the elastic modulus E_{D} is not particularly limited, and may be 250 mm·MPa, 220 mm·MPa, or 200 mm·MPa. When the summation Σ(T×E_{D}) of the product of the average thickness T and the elastic modulus E_{D} is 0.6 mm·MPa or more and 250 mm·MPa or less, the peel strength between the conductor and the insulating film at a high temperature can be improved, and cracking of the insulating layer due to an impact or a vibration can be suppressed.

The summation of the average thickness T of each of the insulating layers is 0.10 mm or more and 1.00 mm or less, and the lower limit of the elastic modulus E_{D} at a temperature D in a temperature range of 70° C. or more and 130° C. or less is preferably 1 MPa, more preferably 3.0 MPa, and further preferably 5.0 MPa. On the other hand, the upper limit of the elastic modulus E_{D} of each of the insulating layers at a temperature D in a temperature range of 70° C. or more and 130° C. or less is preferably 1500 MPa, and more preferably 1000 MPa. When the elastic modulus E_{D} of each of the insulating layers at a temperature D in a temperature range of 70° C. or more and 130° C. or less exceeds 1500 MPa, flexibility may be impaired to cause cracking of the insulating layer due to an impact or a vibration in an automotive application or the like.

The elastic modulus E₁₃₀ at 130° C. of first insulating layer 6 laminated on the surface of conductor 3 is preferably 130 MPa or more, and more preferably 170 MPa or more. When the elastic modulus E₁₃₀ at 130° C. of first insulating layer 6 is 130 MPa or more, the peel strength of the insulating film at a high temperature more increases, and thus the adhesiveness between conductor 3 and insulating film 5 can be more improved.

The elastic modulus E_{D} of each of the insulating layers at a temperature D in a temperature range of 70° C. or more and 130° C. or less can be adjusted by, for example, kneading two or more resins or inorganic fillers having different elastic moduli. Specifically, by adding a resin having a low elastic modulus of about 1 MPa to 5 MPa, such as low-crystallinity polypropylene, to a resin having a high elastic modulus of about 30 MPa, such as homopolypropylene, in an appropriate mass ratio, the elastic modulus E_{D} can be adjusted to the target elastic modulus. In addition, by adding an inorganic filler such as a flame retardant or a filler in an appropriate mass ratio, the elastic modulus E_{D} can be adjusted to a high elastic modulus.

Each of the insulating layers may contain a thermoplastic resin other than the above olefin-based thermoplastic resins, or a further known additive, in a range that does not inhibit the effect of the present disclosure. Examples of the known additive include an antioxidant, a flame retardant, a tackifier, a lubricant, a filler, a crystallization accelerator, and a colorant.

### [Method for Manufacturing Insulating Film]

The method for manufacturing the insulating film of the present disclosure is not particularly limited. For example, respective resin compositions for forming the insulating layers including respective resin components and additives are mixed by using a known mixing apparatus such as an open roll, a pressure kneader, a single-screw mixer, or a twin-screw mixer. Next, when each of the insulating layers is produced, each film-like insulating layer can be produced by extrusion such as T-die molding or inflation molding. Then, the insulating film is produced by overlaying the produced insulating layers and laminating these together by thermal lamination using a hot roll. In addition, as a method for simultaneously forming a plurality of insulating layers, an inflation method or a T-die method using co-extrusion can be used. Furthermore, an extrusion lamination method involving laminating a molten resin on a film formed as a single layer can be used.

When the lead wire for a nonaqueous electrolyte battery uses the insulating film, the lead wire for a nonaqueous electrolyte battery has excellent adhesiveness between the conductor and the insulating film at a high temperature.

### [Method for Manufacturing Lead Wire for Nonaqueous Electrolyte Battery]

The method for manufacturing the lead wire for a nonaqueous electrolyte battery is not particularly limited, and lead wire 1 for a nonaqueous electrolyte battery can be manufactured by a known method.

According to the lead wire for a nonaqueous electrolyte battery, the adhesiveness between the conductor and the insulating film at a high temperature is excellent.

### <Nonaqueous Electrolyte Battery>

The nonaqueous electrolyte battery includes the lead wire for a nonaqueous electrolyte battery described above. Examples of the nonaqueous electrolyte battery include a secondary battery such as a lithium ion battery.

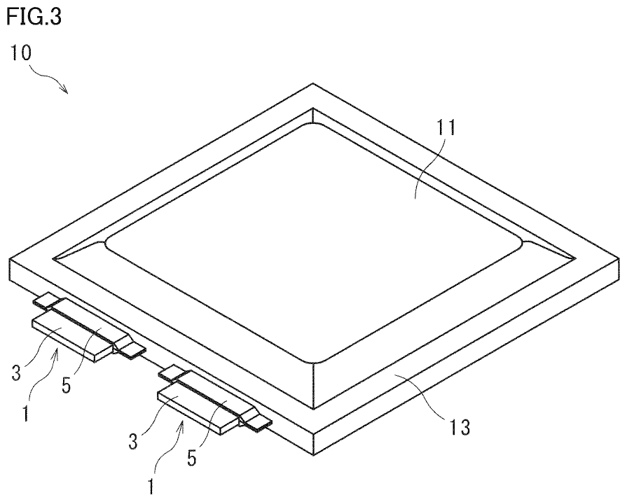

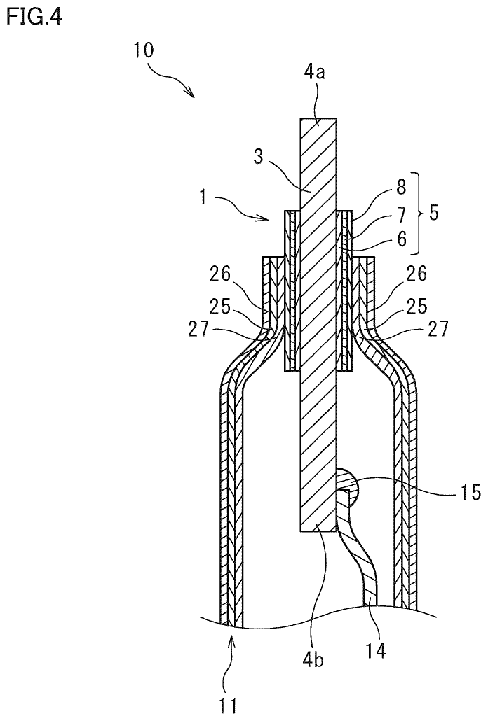

FIG. 3 is a perspective view showing one example of a nonaqueous electrolyte battery including the lead wire for a nonaqueous electrolyte battery. In addition, FIG. 4 is a partial cross-sectional view schematically showing one embodiment of the nonaqueous electrolyte battery. A nonaqueous electrolyte battery (secondary battery) 10 shown in each of FIG. 3 and FIG. 4 includes a plate-like positive electrode, a plate-like negative electrode, and a nonaqueous electrolyte (for example, a nonaqueous electrolytic solution), which are not shown, an enclosure 11, and a plurality of, specifically two, lead wires 1 for a nonaqueous electrolyte battery according to the one embodiment. Lead wires 1 for a nonaqueous electrolyte battery are the lead wires for a nonaqueous electrolyte battery described above. In lead wires 1 for a nonaqueous electrolyte battery according to the present embodiment, insulating film 5 has first insulating layer 6, second insulating layer 7, and third insulating layer 8, as described above. Nonaqueous electrolyte battery 10 has enclosure 11, which is approximately square, and two lead wires 1 for a nonaqueous electrolyte battery extending from the inside to the outside of enclosure 11. Conductor 3 and enclosure 11 are connected at a seal portion 13 of enclosure 11 with insulating film 5 interposed therebetween. Enclosure 11 is a container that accommodates the positive electrode, the negative electrode, a separator, and the nonaqueous electrolytic solution in a hermetically enclosed state.

The positive electrode and the negative electrode, which are not shown, are stacked with a separator interposed therebetween to form a stacked electrode group. The stacked electrode group and the nonaqueous electrolytic solution are accommodated in a hermetically closed state in enclosure 11. In enclosure 11, the stacked electrode group is in a state of being immersed in the electrolytic solution. Enclosure 11 is formed from a sheet body as will be described later. Enclosure 11 is in a hermetically enclosed state by heat sealing of seal portion 13 around the two sheet bodies or one folded sheet body.

Of two lead wires 1 for a nonaqueous electrolyte battery, one end portion 4a of conductor 3 of one lead wire 1 for a nonaqueous electrolyte battery is exposed from enclosure 11, and a further end portion 4b is disposed in such a way as to be connected to the positive electrode inside enclosure 11. End portion 4a of conductor 3 of the other lead wire 1 for a nonaqueous electrolyte battery is exposed from enclosure 11, and further end portion 4b is disposed in such a way as to be connected to the negative electrode inside enclosure 11.

The positive electrode and the negative electrode are each typically a laminate obtained by laminating an active material layer including an active material on the surface of a current collector such as a metal foil. The shape of each of the positive electrode and the negative electrode is usually plate-like, and may be a shape other than the plate-like shape.

The separator is usually an insulating and porous film. This separator is impregnated with a nonaqueous electrolytic solution.

The nonaqueous electrolytic solution includes a nonaqueous solvent and an electrolyte salt dissolved in this nonaqueous solvent.

Enclosure 11 is constituted of a sheet body having an innermost resin layer 27, a metal layer 25, and an outermost resin layer 26 laminated in presented order, as shown in FIG. 4. Then, in enclosure 11, seal portion 13 is formed by overlaying two sheet bodies and heat-sealing three sides other than the side through which the conductor penetrates. In addition, at seal portion 13, conductor 3 of each of lead wires 1 for a nonaqueous electrolyte battery and enclosure 11 are adhered together with insulating film 5 interposed therebetween. Specifically, innermost resin layer 27 of enclosure 11 and third insulating layer 8 of each of lead wires 1 for a nonaqueous electrolyte battery are heat-sealed.

Innermost resin layer 27 of enclosure 11 is not laminated on the surfaces of both end portions of conductor 3 of each of lead wires 1 for a nonaqueous electrolyte battery, that is, one end portion 4a and further end portion 4b. One end portion 4a of conductor 3 is exposed from enclosure 11. On the other hand, a lead wire 14 for internal connection is connected to further end portion 4b of conductor 3 of lead wire 1 for a nonaqueous electrolyte battery on the positive electrode side through a solder portion 15, and conductor 3 is connected to the positive electrode, which is not shown, through lead wire 14 for internal connection. In addition, similarly, lead wire 14 for internal connection is connected to further end portion 4b of conductor 3 of lead wire 1 for a nonaqueous electrolyte battery on the negative electrode side through solder portion 15, and conductor 3 is connected to the negative electrode, which is not shown, through lead wire 14 for internal connection. As shown in FIG. 4, an intermediate portion of lead wire 1 for a nonaqueous electrolyte battery is sandwiched together with insulating film 5 by the sheet body, which is enclosure 11, and at this portion, innermost resin layer 27 of enclosure 11 and third insulating layer 8 on the outermost surface of insulating film 5 of a plurality of lead wires 1 for a nonaqueous electrolyte battery are heat-sealed.

Innermost resin layer 27 is directly laminated on the inner surface of metal layer 25. An insulating resin that does not dissolve in a nonaqueous electrolyte and melts when heated is preferably used for innermost resin layer 27 located inside enclosure 11. For innermost resin layer 27, for example, a polyolefin, an acid-modified polyolefin, an acid-modified styrene-based elastomer, or the like can be used. Among these, a polypropylene is preferable for innermost resin layer 27. In addition, the average thickness of innermost resin layer 27 is preferably about 10 μm to 500 μm.

Metal layer 25 has a function such as improving the strength of enclosure 11 or preventing water vapor, oxygen, light, or the like from entering the inside of the battery. Metal layer 25 is formed from a metal such as aluminum foil. Metal layer 25 includes a metal as a main component. Examples of this metal include aluminum, copper, stainless steel, and titanium, and aluminum is particularly preferable. Metal layer 25 is substantially formed from a metal, and may include an additive other than a metal. Metal layer 25 is film-like, and is preferably formed from a metal foil and more preferably formed from aluminum alloy foil. In addition, the average thickness of metal layer 25 is preferably about 10 μm to 50 μm.

Outermost resin layer 26 has the function of protecting the outer surface of metal layer 25, the function of insulating the same, and the like. Outermost resin layer 26 located outside enclosure 11 usually includes a resin as an insulating material, as a main component. Examples of the resin forming outermost resin layer 26 include polyethylene terephthalate (PET), polyamide, polyester, polyamide, a polyolefin, an epoxy resin, an acrylic resin, a fluororesin, polyurethane, a silicon resin, a phenol resin, polyetherimide, polyimide, and a mixture or a copolymer thereof. In addition, the average thickness of outermost resin layer 26 is preferably about 10 μm to 50 μm.

In nonaqueous electrolyte battery 10, as described above, lead wire 1 for nonaqueous electrolyte battery is sealed by enclosure 11 such that one end thereof, that is, one end portion 4a of conductor 3 is disposed in a state of being exposed from enclosure 11. Specifically, lead wire 1 for a nonaqueous electrolyte battery is disposed such that innermost resin layer 27 of enclosure 11 and insulating film 5 of lead wire 1 for a nonaqueous electrolyte battery are in direct contact with each other. In addition, in a state in which lead wire 1 for a nonaqueous electrolyte battery is disposed as described above, innermost resin layer 27 in seal portion 13 of enclosure 11 and third insulating layer 8 of lead wire 1 for a nonaqueous electrolyte battery are heat-sealed. Thereby, the positive electrode, the negative electrode, and the separator, which constitute the stacked electrode group immersed in the nonaqueous electrolytic solution, can be hermetically enclosed within enclosure 11.

### [Method for Manufacturing Nonaqueous Electrolyte Battery]

The method for manufacturing the nonaqueous electrolyte battery according to one embodiment of the present disclosure can be appropriately selected from known methods. The method for manufacturing the nonaqueous electrolyte battery includes, for example, providing a lead wire for the nonaqueous electrolyte battery, providing a stacked electrode group, providing a nonaqueous electrolyte, and accommodating the stacked electrode group to which the lead wire for the nonaqueous electrolyte battery is connected and the nonaqueous electrolyte in an enclosure.

According to the nonaqueous electrolyte battery of the present embodiment, the nonaqueous electrolyte battery includes the lead wire for a nonaqueous electrolyte battery described above and thus has excellent adhesiveness between the conductor and the insulating film at a high temperature.

### Further Embodiment

The embodiments disclosed herein should be considered in all respects illustrative and not restrictive. The scope of the present disclosure is not limited to the configurations of the above embodiments, but defined by the claims, and is intended to encompass meanings equivalent to the scope of the claims, and all changes within the scope.

### Examples

Hereinafter, the present invention will be described more specifically with reference to Examples, but the present invention is not limited the following Examples.

Materials used are shown below.

### [Conductor]

Aluminum plate (average thickness: 0.40 mm)

### [Insulating Films]

### (PP1)

Acid-modified random polypropylene: “ADMER QE060” manufactured by Mitsui Chemicals, Inc.

### (PP2)

Product obtained by kneading homopolypropylene: 85 parts by mass of “FY6C” manufactured by Japan Polypropylene Corporation and acid-modified polypropylene: 15 parts by mass of “HARDLEN PMA H-1100P” manufactured by TOYOBO Co., Ltd.

### (PP3)

Random polypropylene: “Prime Polypro F227D” manufactured by Prime Polypro

### (PP4)

Random polypropylene: “SunAllomer PF621S” manufactured by SunAllomer Ltd.

### (PP5)

Homopolypropylene: “SA3A” manufactured by Japan Polypropylene Corporation

### (PP6)

Acid-modified random polypropylene: “ADMER QF580” manufactured by Mitsui Chemicals, Inc.

### (PP7)

Random polypropylene: “SunAllomer PF724S” manufactured by SunAllomer Ltd

### (PP8)

Homopolypropylene: “MA3H” manufactured by Japan Polypropylene Corporation

### (PP9)

Acid-modified homopolypropylene: “ADMER QF500” manufactured by Mitsui Chemicals, Inc.

### (PP10)

Product obtained by kneading block polypropylene: 85 parts by mass of “PC480S” manufactured by SunAllomer Ltd. and acid-modified polyolefin: 15 parts by mass of “HARDLEN PMA H-1100P” manufactured by TOYOBO Co., Ltd.

### (PP11)

Product obtained by kneading homopolypropylene: 85 parts by mass of “FB3B” manufactured by Japan Polypropylene Corporation and acid-modified polypropylene: 15 parts by mass of “HARDLEN PMA H-1100P” manufactured by TOYOBO Co., Ltd.

### [No. 1 to No. 4]

### (Production of Insulating Film)

A resin listed in Table 1 was used as a material for a resin composition of the first insulating layer (conductor covering layer) to produce the resin composition of the first insulating layer having a formulation listed in Table 1 by using a mixing apparatus. By using a film forming machine including a single-screw extruder, the first insulating layer resin composition was fed into the extruder and extruded to obtain a one-layer insulating film formed from the first insulating layer resin composition. At this time, the average thickness of the first insulating layer was 0.10 mm.

### (Production of Lead Wire for Nonaqueous Electrolyte Battery)

Next, the obtained one-layer insulating film was cut into a predetermined size, and subjected to heat sealing on both sides of the conductor under conditions of a mold temperature of 220° C. and a surface pressure of 0.3 MPa. Then No. 1 to No. 4 lead wires for a nonaqueous electrolyte battery were obtained.

### [No. 5 to No. 11]

### (Production of Lead Wire for Nonaqueous Electrolyte Battery)

Resins listed in Table 1 were used as materials for resin compositions of the first insulating layer and the second insulating layer to produce the respective resin compositions of the first insulating layer and the second insulating layer having a formulation listed in Table 1 by using a mixing apparatus. By using a coat-hanger type two-type two-layer T-die film-forming machine including two single-screw extruders, the first insulating layer resin composition and the second insulating layer resin composition were fed into the first extruder and the second extruder, respectively, and co-extruded to obtain a two-layer insulating film laminated in the order of first insulating layer resin composition/second insulating layer resin composition. The average thickness of each insulating layer is shown in Table 1. Next, the obtained two-layer insulating film was cut into a predetermined size, and subjected to heat sealing on both sides of the conductor under conditions of a mold temperature of 220° C. and a surface pressure of 0.3 MPa. Then No. 5 to No. 11 lead wires for a nonaqueous electrolyte battery were obtained.

### [No. 12 to No. 17]

### (Production of Lead Wire for Nonaqueous Electrolyte Battery)

Resins listed in Table 1 were used as materials for resin compositions of the first insulating layer, the second insulating layer, and the third insulating layer to produce the respective resin compositions of the first insulating layer, the second insulating layer, and the third insulating layer having a formulation listed in Table 1 by using a mixing apparatus. By using a coat-hanger type three-type three-layer T-die film-forming machine including three single-screw extruders, the first insulating layer resin composition, the second insulating layer resin composition, and the third insulation layer resin composition were fed into the first extruder, the second extruder, and the third extruder, respectively, and co-extruded to obtain a three-layer insulating film laminated in the order of first insulating layer resin composition/second insulating layer resin composition/third insulation layer resin composition. The average thickness of each insulating layer is shown in Table 1. Next, the obtained three-layer insulating film was cut into a predetermined size, and subjected to heat sealing on both sides of the conductor under conditions of a mold temperature of 220° C. and a surface pressure of 0.3 MPa. Then No. 12 to No. 17 lead wires for a nonaqueous electrolyte battery were obtained.

### [Evaluation]

### (Measurement of Elastic Modulus)

Each insulating layer of the insulating film of each of the obtained No. 1 to No. 17 lead wires for a nonaqueous electrolyte battery was measured for elastic moduli at 70° C., 100° C., and 130° C. by the method described above by using a nanoindenter. Results thereof are shown in Table 1.

### (Peel Strength)

The peel strength between the insulating film and the conductor was measured by the following procedure.

The tab lead was cut into a predetermined size (width of 1 cm) in the longitudinal direction, then a part of the insulating film and the conductor were cut such that a cut was made to the insulating film surface on the bottom side in a direction perpendicular to the longitudinal direction. A part of the uncut insulating film on the bottom side was peeled off from the conductor, the exposed portion of the conductor was attached to a tensile tester and fixed, and the conductor separated off in a state in which the insulating film on the bottom side was partially connected was pulled to measure the peel strength. TGI-2 kN manufactured by MinebeaMitsumi Inc. was used as the tensile tester, a load cell having a capacity of 1 kN was used, and the thermostatic bath option THB-B was used as a high-temperature environment; and 3 minutes after a thermostatic bath stabilized at the target temperature (130° C.) after a sample was fed in, a peel test was carried out. The distance between the chucks was set to 20 mm, the upper chuck held the conductor separated off in a state in which the insulating film on the bottom side was partially connected, the lower chuck held the other conductor, and the upper chuck was operated in such a way as to cause 180° peeling, to carry out the peel test at a peel speed of 50 mm/min to measure the peel strength [N/cm]. The peel strength value [N/cm] in the 180° peel test shown in the table is the value obtained by dividing the maximum test force obtained by the test by the width of the test piece. Results thereof are shown in Table 1.

### (Overall Determination of Peel Test Results)

Overall determination was made based on the results of the peel strength under the environment of 130° C. measured above. The overall determination was rating on a 6-grade scale from SA to D. The evaluation criteria for the overall determination were as follows. If the rating is SA to C, the lead wire is considered to be acceptable. Results thereof are shown in Table 1.
SA: The peel strength is more than 7 N/cm.
AA: The peel strength is more than 6 N/cm and 7 N/cm or less.
A: The peel strength is more than 5 N/cm and 6 N/cm or less.
B: The peel strength is more than 3 N/cm and 5 N/cm or less.
C: The peel strength is more than 0 N/cm and 3 N/cm or less.
D: The peel strength is 0 N/cm.

TABLE 1

| | | | | No. | No. | No. | No. | No. | No. | No. | No. | No. |
|---|---|---|---|---|---|---|---|---|---|---|---|---|
| | | | | 1 | 2 | 3 | 4 | 5 | 6 | 7 | 8 | 9 |
| Tab | Insulating | Third | Material | — | — | — | — | — | — | — | — | — |
| lead | film | insulating | 70° C. elastic | — | — | — | — | — | — | — | — | — |
| | | layer | modulus [MPa] | | | | | | | | | |
| | | | 100° C. elastic | — | — | — | — | — | — | — | — | — |
| | | | modulus [MPa] | | | | | | | | | |
| | | | 120° C. elastic | — | — | — | — | — | — | — | — | — |
| | | | modulus [MPa] | | | | | | | | | |
| | | | 130° C. elastic | — | — | — | — | — | — | — | — | — |
| | | | modulus [MPa] | | | | | | | | | |
| | | | Average thickness | — | — | — | — | — | — | — | — | — |
| | | | T3 [mm] | | | | | | | | | |
| | | Second | Material | — | — | — | — | PP3 | PP3 | PP3 | PP3 | PP3 |
| | | insulating | 70° C. elastic | — | — | — | — | 420 | 420 | 420 | 420 | 420 |
| | | layer | modulus [MPa] | | | | | | | | | |
| | | | 100° C. elastic | — | — | — | — | 190 | 190 | 190 | 190 | 190 |
| | | | modulus [MPa] | | | | | | | | | |
| | | | 120° C. elastic | — | — | — | — | 80 | 80 | 80 | 80 | 80 |
| | | | modulus [MPa] | | | | | | | | | |
| | | | 130° C. elastic | — | — | — | — | 7 | 7 | 7 | 7 | 7 |
| | | | modulus [MPa] | | | | | | | | | |
| | | | Average thickness | — | — | — | — | 0.05 | 0.05 | 0.10 | 0.05 | 0.05 |
| | | | T2 [mm] | | | | | | | | | |
| | | First | Material | PP2 | PP1 | PP10 | PP11 | PP10 | PP11 | PP1 | PP1 | PP1 |
| | | insulating | 70° C. elastic | 840 | 310 | 600 | 700 | 600 | 700 | 310 | 310 | 310 |
| | | layer | modulus [MPa] | | | | | | | | | |
| | | (conductor | 100° C. elastic | 430 | 170 | 360 | 380 | 360 | 380 | 170 | 170 | 170 |
| | | covering | modulus [MPa] | | | | | | | | | |
| | | layer) | 120° C. elastic | 350 | 50 | 260 | 280 | 260 | 280 | 50 | 50 | 50 |
| | | | modulus [MPa] | | | | | | | | | |
| | | | 130° C. elastic | 300 | 3 | 140 | 180 | 140 | 180 | 3 | 3 | 3 |
| | | | modulus [MPa] | | | | | | | | | |
| | | | Average thickness | 0.10 | 0.10 | 0.10 | 0.10 | 0.05 | 0.05 | 0.10 | 0.10 | 0.05 |
| | | | T1 [mm] | | | | | | | | | |

| | | | | | | | | | |
|---|---|---|---|---|---|---|---|---|---|
| Insulating film | 0.10 | 0.10 | 0.10 | 0.10 | 0.10 | 0.10 | 0.20 | 0.15 | 0.10 |
| Average thickness | | | | | | | | | |
| T1 + T2 + T3 [mm] | | | | | | | | | |

| | | | | | | | | | | |
|---|---|---|---|---|---|---|---|---|---|---|
| Summation Σ(T × E_{D}) of | 70° C. | 84.0 | 31.0 | 60.0 | 70.0 | 51.0 | 56.0 | 73.0 | 52.0 | 36.6 |
| product of average | 100° C. | 43.0 | 17.0 | 36.0 | 38.0 | 27.5 | 28.5 | 36.0 | 26.5 | 18.0 |
| thickness T of each layer | 120° C. | 35.0 | 5.0 | 26.0 | 28.0 | 17.0 | 18.0 | 13.0 | 9.0 | 6.5 |
| and elastic modulus E_{D} | 130° C. | 30.0 | 0.3 | 14.0 | 18.0 | 7.4 | 9.4 | 1.0 | 0.7 | 0.5 |
| thereol at temperature D | | | | | | | | | | |
| [mm · MPa] | | | | | | | | | | |

| | | | | | | | | | | |
|---|---|---|---|---|---|---|---|---|---|---|
| Evaluation | 130° C. peel strength [N/cm] | 12.3 | 0.0 | 6.8 | 8.0 | 6.2 | 6.4 | 2.8 | 1.9 | 0.0 |
| | Determination | SA | D | AA | SA | AA | AA | C | C | D |

| | | | | No. | No. | No. | No. | No. | No. | No. | No. |
|---|---|---|---|---|---|---|---|---|---|---|---|
| | | | | 10 | 11 | 12 | 13 | 14 | 15 | 16 | 17 |
| Tab | Insulating | Third | Material | — | — | PP4 | PP4 | PP4 | PP7 | PP7 | PP7 |
| lead | film | insulating | 70° C. elastic | — | — | 270 | 270 | 270 | 500 | 500 | 500 |
| | | layer | modulus [MPa] | | | | | | | | |
| | | | 100° C. elastic | — | — | 120 | 120 | 120 | 220 | 220 | 220 |
| | | | modulus [MPa] | | | | | | | | |
| | | | 120° C. elastic | — | — | 60 | 60 | 60 | 130 | 130 | 130 |
| | | | modulus [MPa] | | | | | | | | |
| | | | 130° C. elastic | — | — | 10 | 10 | 10 | 70 | 70 | 70 |
| | | | modulus [MPa] | | | | | | | | |
| | | | Average thickness | — | — | 0.07 | 0.05 | 0.03 | 0.07 | 0.05 | 0.03 |
| | | | T3 [mm] | | | | | | | | |
| | | Second | Material | PP3 | PP3 | PP5 | PP5 | PP5 | PP8 | PP8 | PP8 |
| | | insulating | 70° C. elastic | 420 | 420 | 720 | 720 | 720 | 790 | 790 | 790 |
| | | layer | modulus [MPa] | | | | | | | | |
| | | | 100° C. elastic | 190 | 190 | 370 | 370 | 370 | 380 | 380 | 380 |
| | | | modulus [MPa] | | | | | | | | |
| | | | 120° C. elastic | 80 | 80 | 250 | 250 | 250 | 330 | 330 | 330 |
| | | | modulus [MPa] | | | | | | | | |
| | | | 130° C. elastic | 7 | 7 | 50 | 50 | 50 | 270 | 270 | 270 |
| | | | modulus [MPa] | | | | | | | | |
| | | | Average thickness | 0.05 | 0.05 | 0.07 | 0.05 | 0.04 | 0.07 | 0.05 | 0.04 |
| | | | T2 [mm] | | | | | | | | |
| | | First | Material | PP2 | PP2 | PP6 | PP6 | PP6 | ppg | PP9 | PP9 |
| | | insulating | 70° C. elastic | 840 | 840 | 300 | 300 | 300 | 750 | 750 | 750 |
| | | layer | modulus [MPa] | | | | | | | | |
| | | (conductor | 100° C. elastic | 430 | 430 | 140 | 140 | 140 | 390 | 390 | 390 |
| | | covering | modulus [MPa] | | | | | | | | |
| | | layer) | 120° C. elastic | 350 | 350 | 70 | 70 | 70 | 310 | 310 | 310 |
| | | | modulus [MPa] | | | | | | | | |
| | | | 130° C. elastic | 300 | 300 | 15 | 15 | 15 | 250 | 250 | 250 |
| | | | modulus [MPa] | | | | | | | | |
| | | | Average thickness | 0.10 | 0.05 | 0.07 | 0.05 | 0.03 | 0.07 | 0.05 | 0.03 |
| | | | T1 [mm] | | | | | | | | |

| | | | | | | | | |
|---|---|---|---|---|---|---|---|---|
| Insulating film | 0.15 | 0.10 | 0.21 | 0.15 | 0.10 | 0.21 | 0.15 | 0.10 |
| Average thickness | | | | | | | | |
| T1 + T2 + T3 [mm] | | | | | | | | |

| | | | | | | | | | |
|---|---|---|---|---|---|---|---|---|---|
| Summation Σ(T × E_{D}) of | 70° C. | 105.0 | 63.0 | 90.3 | 64.5 | 45.9 | 142.8 | 102.0 | 69.1 |
| product of average | 100° C. | 52.5 | 31.0 | 44.1 | 31.5 | 22.6 | 69.3 | 49.5 | 33.5 |
| thickness T of each layer | 120° C. | 39.0 | 21.5 | 26.6 | 19.0 | 13.9 | 53.9 | 38.5 | 26.4 |
| and elastic modulus E_{D} | 130° C. | 30.4 | 15.4 | 5.3 | 3.8 | 2.8 | 41.3 | 29.5 | 20.4 |
| thereol at temperature D | | | | | | | | | |
| [mm · MPa] | | | | | | | | | |

| | | | | | | | | | |
|---|---|---|---|---|---|---|---|---|---|
| Evaluation | 130° C. peel strength [N/cm] | 10.2 | 7.3 | 5.1 | 3.7 | 2.0 | 13.3 | 11.0 | 8.3 |
| | Determination | SA | SA | A | B | C | SA | SA | SA |

As shown in Table 1, No. 1, No. 3 to No. 8, and No. 10 to No. 17 in which the summation Σ(T×E_{D}) of the product of the average thickness T of each of the insulating layers of the insulating film and the elastic modulus E_{D} thereof at a temperature D in a temperature range of 70° C. or more and 130° C. or less was 0.6 mm·MPa or more had good peel strength at 130° C. In particular, No. 1, No. 3 to No. 6, No. 10 to No. 12, and No. 15 to No. 17 in which the summation Σ(T×E_{D}) of the product of the average thickness T of each of the insulating layers and the elastic modulus E_{D} thereof was 5.0 mm·MPa or more had particularly excellent peel strength at 130° C.

On the other hand, the No. 2 and No. 9 lead wires for a nonaqueous electrolyte battery in which the summation Σ(T×E_{D}) of the product of the average thickness T of each of the insulating layers and the elastic modulus E_{D} thereof was less than 0.6 had a very low peel strength value at 130° C.

The above results showed that the lead wire for a nonaqueous electrolyte battery has excellent adhesiveness between the conductor and the insulating film at a high temperature.

### REFERENCE SIGNS LIST

1 Lead wire for nonaqueous electrolyte battery;
3 Conductor;
4a One end portion;
4b Further end portion;
5 Insulating film;
6 First insulating layer;
7 Second insulating layer;
8 Third insulating layer;
10 Nonaqueous electrolyte battery;
11 Enclosure;
13 Seal portion;
14 Lead wire for internal connection;
15 Solder portion;
25 Metal layer;
26 Outermost resin layer;
27 Innermost resin layer

1. A lead wire for a nonaqueous electrolyte battery, comprising:
a conductor; and
an insulating film having one or more insulating layers and covering at least a part of an outer peripheral surface of the conductor, wherein
a summation Σ(T×E_{D}) of a product of an average thickness T of each of the insulating layers and an elastic modulus E_{D} thereof at a temperature D in a temperature range of 70° C. or more and 130° C. or less is 0.6 mm·MPa or more.

2. The lead wire for a nonaqueous electrolyte battery according to claim 1, wherein a summation of the average thickness T of each of the insulating layers is 0.10 mm or more and 1.00 mm or less, and
the elastic modulus E_{D} of each of the insulating layers is 1 MPa or more.

3. The lead wire for a nonaqueous electrolyte battery according to claim 1, wherein the summation Σ(T×E_{D}) of the product of the average thickness T of each of the insulating layers and the elastic modulus E_{D} thereof is 3.0 mm·MPa or more.

4. The lead wire for a nonaqueous electrolyte battery according to claim 3, wherein a summation of the average thickness T of each of the insulating layers is 0.10 mm or more and 1.00 mm or less, and
the elastic modulus E_{D} of each of the insulating layers is 3.0 MPa or more.

5. The lead wire for a nonaqueous electrolyte battery according to claim 3, wherein the summation Σ(T×E_{D}) of the product of the average thickness T of each of the insulating layers and the elastic modulus E_{D} thereof is 5.0 mm·MPa or more.

6. The lead wire for a nonaqueous electrolyte battery according to claim 5, wherein a summation of the average thickness T of each of the insulating layers is 0.10 mm or more and 1.00 mm or less, and
the elastic modulus E_{D} of each of the insulating layers is 5.0 MPa or more.

7. The lead wire for a nonaqueous electrolyte battery according to claim 1, wherein the summation Σ(T×E_{D}) of the product of the average thickness T of each of the insulating layers and the elastic modulus E_{D} thereof is 7.0 mm·MPa or more.

8. The lead wire for a nonaqueous electrolyte battery according to claim 7, wherein the summation Σ(T×E_{D}) of the product of the average thickness T of each of the insulating layers and the elastic modulus E_{D} thereof is 15.0 mm·MPa or more.

9. The lead wire for a nonaqueous electrolyte battery according to claim 1, wherein the insulating film has a first insulating layer laminated on a surface of the conductor, and
an elastic modulus E₁₃₀ at 130° C. of the first insulating layer is 130 MPa or more.

10. The lead wire for a nonaqueous electrolyte battery according to claim 9, wherein the first insulating layer comprises a polypropylene or an acid-modified polypropylene having a melting point of 150° C. or more as a main component.

11. An insulating film used for the lead wire for a nonaqueous electrolyte battery according to claim 1.

12. A nonaqueous electrolyte battery comprising:
an enclosure; and
a plurality of the lead wires for a nonaqueous electrolyte battery according to claim 1 disposed in such a way as to extend from the inside of the enclosure to the outside, wherein
the enclosure is constituted of a sheet body having an innermost resin layer, a metal layer, and an outermost resin layer laminated in presented order, and
the innermost resin layer and the insulating layer on an outermost surface of the insulating film are heat-sealed.
